(19) United States
(12) Patent Application Publication
(10) Pub. No.: US 2023/0273413 A1
(43) Pub. Date: Aug. 31, 2023

(54) LENS SYSTEM AND PROJECTOR

(71) Applicant: NITTOH INC., Suwa-shi, Nagano (JP)

(72) Inventors: Keiichi MOCHIZUKI, Suwa-shi, Nagano (JP); Yuya MIYASHITA, Suwa-shi, Nagano (JP)

(21) Appl. No.: 17/924,001

(22) PCT Filed: May 11, 2021
(86) PCT No.: PCT/JP2021/017790

§ 371 Date: Nov. 8, 2022

(30) Foreign Application Priority Data
May 12, 2020 (JP) 2020-083811

(51) Int. Cl. G02B 15/14; G02B 13/02

(52) U.S. Cl. CPC G02B 15/1421; G02B 13/02; G03B 3/10

(57) ABSTRACT

There is provided a lens system composed, in order from an enlargement side, of a first lens group with positive refractive power and a second lens group with positive refractive power, wherein when zooming from a telephoto end to a wide-angle end, a distance between the first lens group and the second lens group decreases and a distance between the second lens group and a conjugate plane on a reduction side increases. The second lens group includes, closest to an enlargement side thereof, a lens with a second end surface that is concave on the enlargement side, and the first lens group includes a lens with an effective diameter of a first end surface closest to the reduction side that is larger than a maximum diameter in the second lens group.

### TECHNICAL FIELD

The present invention relates to a lens system and a projector including the same.

### BACKGROUND ART

Japanese Laid-open Patent Publication No. 2019-168655 discloses a small lighting device. This lighting device includes an illumination optical system that guides light from a light source to an illuminated region and is equipped, in order from the illuminated region, a first lens unit and a second lens unit. With this illumination optical system, the distance between the first lens unit and the second lens unit is reduced when increasing the area of the illuminated region, and when the focal length of the first lens unit is expressed as “f1” and the focal length of the second lens unit is expressed as “f2”, a condition f1>f2 is satisfied.

### SUMMARY OF INVENTION

The lighting device described above is small and bright, and the area of the illuminated region is variable, or in other words, the lighting device has a zoom function. However, the projection of images by this lighting device is not considered, and the image forming performance as a projection optical system is low.

One aspect of the present invention is a lens system consisting of, in order from an enlargement side, a first lens group with positive refractive power and a second lens group with positive refractive power. This lens system is a positive-positive zoom lens system, and when zooming from a telephoto end to a wide-angle end, a distance between the first lens group and the second lens group decreases and a distance between the second lens group and a conjugate plane on a reduction side increases. In addition, the second lens group includes, closest to an enlargement side thereof, an enlargement-side lens with a second end surface that is concave on the enlargement side, and in the first lens group, an effective diameter of a first end surface closest to the reduction side is larger than a maximum diameter of the second lens group.

A zoom lens system composed of lens groups with positive-positive refractive power is typically a lens system that is compact and bright, has a comparatively short overall length, and can achieve a certain back focus. However, to achieve a sufficient zoom ratio, it is necessary to increase the change in the distance between the two lens groups, and there is a tendency for the F number at the telephoto end to decrease. In this lens system, in which the lens groups have positive-positive refractive power and surfaces that are convex on the enlargement side are consecutive, the second end surface that is concave on the enlargement side is provided closest to the enlargement side of the second lens group, and the effective diameter of the first end surface that is closest to the reduction side of the first lens group and faces the second end surface is set larger than the maximum diameter of the second lens group. With this configuration, it is possible to introduce a concave surface, which has a comparatively small radius of curvature and is capable of dispersing light rays, as the second end surface. By introducing the concave surface with a small radius of curvature, it is possible to lower the Petzval sum, to improve the aberration correction performance of the lens system, and to improve the image forming performance. By increasing the effective diameter of the first end surface that is closest to the reduction side of the first lens group, it is possible to reduce the blocking of light rays by the first lens group at the telephoto end and possible to provide a lens system that is brighter and has a lower F number.

A typical configuration of the second lens group includes an enlargement-side lens with negative refractive power that is disposed closest to the enlargement side and a reduction-side lens with positive refractive power that is disposed closest to the reduction side, and it is possible to introduce a negative-positive or so-called retrofocus-type arrangement of refractive powers into the configuration of the second lens group. By doing so, it is possible to produce a state where the light rays on the reduction side are in a telecentric or near telecentric state with a long back focus, which makes it possible for light to be efficiently transmitted between the lens system and an image pickup element or an image forming device disposed on the reduction side. In a typical configuration of the lens system, the first lens group is composed of a single lens with positive refractive power that is convex on the enlargement side, and the second lens group is composed of three lenses made up of the enlargement-side lens with negative refractive power that includes the second end surface that is concave on the enlargement side, a lens with positive refractive power that is convex on the reduction side, and the reduction-side lens that has positive refractive power and is convex on the reduction side.

Another aspect of the present invention is a projector including the lens system described above and an image forming device disposed at the conjugate plane on the reduction side. Yet another aspect of the present invention is an image pickup apparatus including the lens system described above and an image pickup element disposed at the conjugate plane on the reduction side.

### BRIEF DESCRIPTION OF DRAWINGS

FIGS. 1A and 1B depict the overall configuration of a lens system and a projector;

FIG. 2 shows lens data;

FIG. 3 shows aspherical surface coefficients;

FIG. 4 shows various numerical values at a telephoto end and a wide-angle end;

FIGS. 5A and 5B depict various aberrations at the telephoto end and the wide-angle end;

FIG. 6 depicts lateral aberration at the telephoto end;

FIG. 7 depicts lateral aberration at the wide-angle end;

FIGS. 8A and 8B depict the overall configuration of a different embodiment of lens system and projector;

FIG. 9 shows lens data;

FIG. 10 shows aspherical surface coefficients;

FIG. 11 shows various numerical values at the telephoto end and the wide-angle end;

FIGS. 12A and 12B depict various aberrations at the telephoto end and the wide-angle end;

FIG. 13 depicts lateral aberration at the telephoto end;

FIG. 14 depicts lateral aberration at the wide-angle end;

FIGS. 15A and 15B depict the overall configuration of yet another embodiment of lens system and projector;

FIG. 16 shows lens data;

FIG. 17 shows aspherical surface coefficients;

FIG. 18 shows various numerical values at the telephoto end and the wide-angle end;

FIGS. 19A and 19B depict various aberrations at the telephoto end and the wide-angle end;

FIG. 20 depicts lateral aberration at the telephoto end; and

FIG. 21 depicts lateral aberration at the wide-angle end.

### DESCRIPTION OF EMBODIMENTS

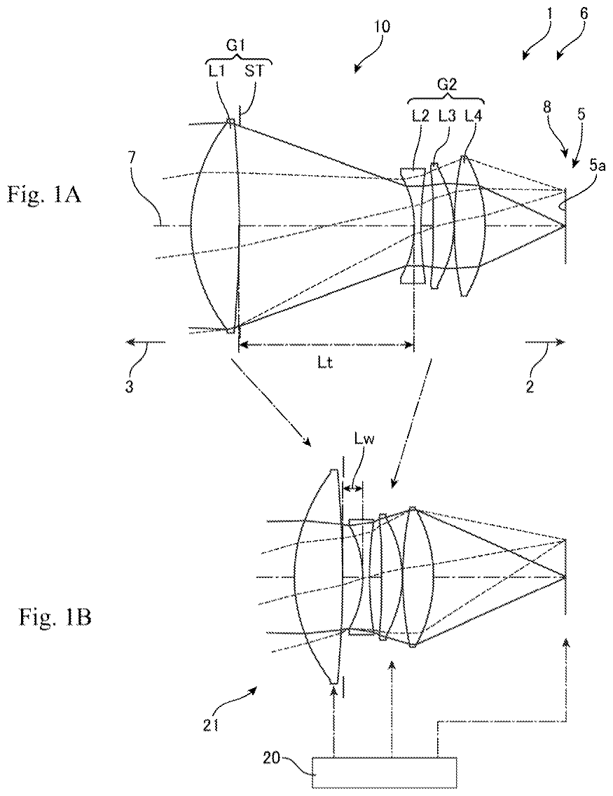

The present invention will now be described further with reference to the drawings. FIG. 1 depicts an apparatus including a lens system according to an embodiment of the present invention. One example apparatus is a projector (projector apparatus) 1, which includes a lens system 10 and an image forming device 5 disposed on a reduction side 2. The lens system 10 of the projector 1 projects images formed on a display surface of an image forming device (light modulator or light valve) 5, as examples, a liquid crystal panel or a digital mirror device, disposed at a conjugate plane 5a on the reduction side 2, onto a screen, wall, or the like (not illustrated) on an enlargement side (projection side) 3. One example of a different apparatus including the lens system 10 is an image pickup apparatus (imaging device) 6, which includes an image pickup element 8 disposed on the reduction side 2. The lens system for an image pickup apparatus 10 uses light incident from the enlargement side (object side) 3 to form an image on an image pickup surface of the image pickup element 8, which is an image forming surface (conjugate plane) on the reduction side 2. Since the lens system 10 has the same or common configuration and functions regardless of whether it is a lens system for an image pickup apparatus or a lens system for a projector, in the following description, the projector 1 and the lens system 10 for a projector are described in detail as examples.

FIG. 1A depicts the lens arrangement of the lens system 10 at the telephoto end and FIG. 1B depicts the lens arrangement of the lens system 10 at the wide-angle end. The projector 1 includes an optical system (image pickup optical system, image forming optical system, or simply, lens system) 10 and an image forming device 5 disposed on the reduction side (image side) 2 of the optical system 10. The optical system 10 is a zoom lens system 10 for projecting images, and is a lens system configured with four elements in two groups. In more detail, the lens system 10 is composed, in order from the enlargement side (screen side) 3, of a first lens group G1 with positive refractive power and a second lens group G2 with positive refractive power. When changing the magnification (zooming) from the telephoto end to the wide-angle end, the distance (spacing) between the first lens group G1 and the second lens group G2 decreases (narrows) and the distance (spacing) between the second lens group G2 and the image forming device 5 disposed at the conjugate plane on the reduction side 2 increases (widens). The distance between the first lens group G1 and the second lens group G2 indicates a distance on an optical axis 7 between a surface (first end surface) that is closest to the reduction side 2 of the first lens group G1 and a surface (second end surface) that is closest to the enlargement side of the second lens group G2. The distance between the second lens group G2 and the image forming device 5 indicates the distance on the optical axis 7 between the surface on the reduction side of the lens closest to the reduction side of the second lens group G2 and the image forming device 5. The lens system 10 is a varifocus (varifocal) lens where the first lens group G1 and the second lens group G2 integrally move at the telephoto end and at the wide-angle end during focusing.

The lens system 10 may include a driving unit (actuating unit, actuator) 20 that moves at least one of the first lens group G1, the second lens group G2, and the image forming device 5 at the conjugate plane on the reduction side 2 either alone or in concert, and may be provided as a lens unit 21 including the lens system 10 and the driving unit 20. As one example, the driving unit 20 may control the above distances (intervals) during zooming and focusing by moving the first lens group G1 and the second lens group G2 in concert with the image forming device 5 fixed. Alternatively, the driving unit 20 may fix either the first lens group G1 or the second lens group G2 and move the other lens group and the image forming device 5 to control the above distances (intervals) during zooming and focusing.

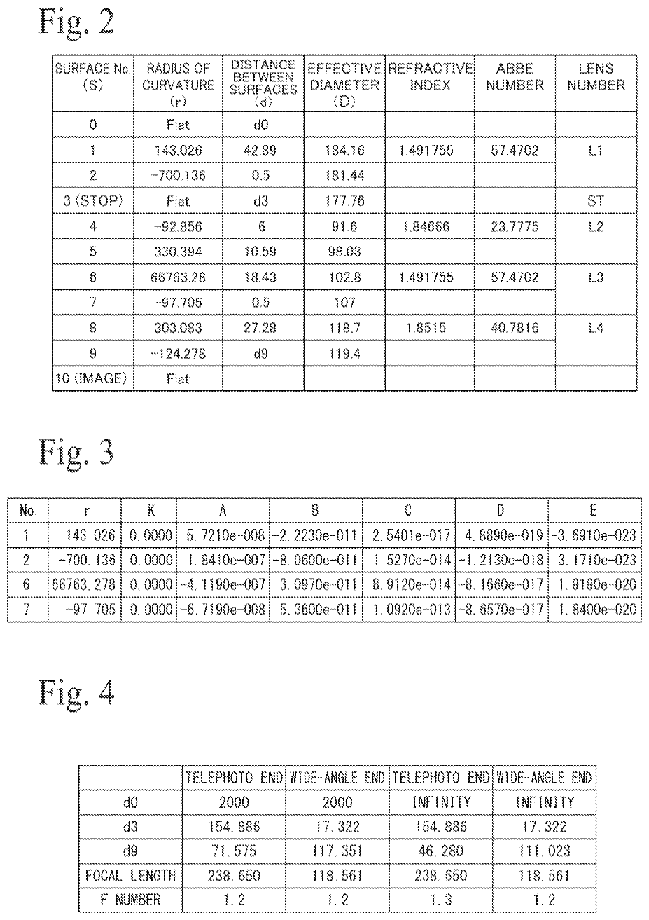

FIG. 2 indicates data on each lens that constructs the lens system 10. The radius of curvature r is the radius of curvature (in mm) of each surface S of each lens arranged in order from the enlargement side 3, the distance d is the distance (in mm) between the respective lens surfaces, the effective diameter D is the effective diameter (in mm) of each lens surface, the refractive index (n) indicates the refractive index (d line) of each lens, and the Abbe number (v) indicates the Abbe number (d line) of each lens. The same applies to the other lens systems described below.

FIG. 3 indicates coefficients of the aspherical surfaces included in the lens system 10. In the present embodiment, the surface S1 on the enlargement side and the surface S2 on the reduction side of the first lens group G1, and the surface S6 on the enlargement side and the surface S7 on the reduction side of the lens L3 of the second lens group G2 are aspherical surfaces. The aspherical surfaces are expressed by the following equation (X) using the coefficients K, A, B, C, D, and E indicated in FIG. 3, where X is the coordinate in the optical axis direction, Y is the coordinate in a direction perpendicular to the optical axis, the direction in which light propagates is positive, and r is the paraxial radius of curvature. The same applies to the embodiments described later. Note that “en” means “10 to the n^{th} power”.

X=(1/r)Y²/[1+{1−(1+K)(1/r)²Y²}^{1/2}]+AY⁴+BY⁶+CY⁸+DY¹⁰+EY¹² (X)

In FIG. 4, the variable distances d3 and d9, the focal length of the entire system, and the F number are indicated for when the distance d0 to the projection surface (screen) at the telephoto end (“TELE”) of the lens system 10 is the minimum distance (2000 mm), when the distance d0 to the projection surface at the wide-angle end (“WIDE”) is the minimum distance (2000 mm), when the distance d0 to the projection surface (screen) at the telephoto end (“TELE”) of the lens system 10 is infinity (“INFINITY”), and when the distance d0 to the projection surface at the wide-angle end (“WIDE”) is infinity (“INFINITY”).

This lens system 10 is a zoom lens system with a two-group configuration composed of the lens groups G1 and G2 that have positive-positive refractive power, and is a compact and bright lens system that has a minimal or close to minimal configuration as a zoom lens, has a comparatively short overall length, and can achieve a certain back focus. In addition, the second lens group G2, at a position closest to the enlargement side, includes a lens (enlargement-side lens) L2 with a surface (in the present embodiment, the surface S4 or “second end surface”) that is concave on the enlargement side. The first lens group G1 includes the lens L1 for which the effective diameter (in the present embodiment, D2) of the surface closest to the reduction side (in the present embodiment, the surface S2 or “first end surface”) is larger than the maximum diameter in the second lens group G2 (in the present embodiment, the surface S9 on the reduction side 2 of the lens (reduction-side lens) L4 closest to the reduction side 2).

In the positive-positive two-group zoom lens system 10, to achieve a sufficient zoom ratio, it is necessary to increase the change in distance between the two lens groups G1 and G2. That is, compared to the distance Lw (a distance on the optical axis 7) between the first lens group G1 and the second lens group G2 at the wide-angle end, the distance Lt between the first lens group G1 and the second lens group G2 at the telephoto end needs to be made sufficiently large (wide). However, there is a tendency for the F number at the telephoto end to decrease as this distance increases.

In this lens system 10, in the lens groups G1 and G2 that have positive-positive refractive power and where surfaces that are convex on the enlargement side 3 are consecutive (included or arranged), a concave surface is provided as the surface S4 on the enlargement side 3 (second end surface) of the lens L2 that is closest to the enlargement side 3 among the lenses of the second lens group G2. In addition, the effective diameter D2 of the first end surface S2 that is closest to the reduction side 2 of the first lens group G1 and faces this second end surface S4 is made larger than the maximum diameter in the second lens group G2. This makes it possible to design the end surface S4 on the enlargement side 3 of the second lens group G2 so as to cause dispersion (that is, spreading or widening in a direction away from the optical axis 7) of light (luminous) flux that has been directed toward the first end surface S2 that has a large diameter on the enlargement side 3 along the optical axis 7, and introduce a concave surface with a comparatively small radius of curvature that is suited to dispersing light rays into the lens system 10 as the second end surface S4. By including the surface S4 that is concave on the enlargement side 3 with a small radius of curvature, it is possible to reduce the Petzval sum of the lens system 10. Accordingly, it is possible to improve the aberration correcting performance of the lens system 10 and thereby improve the image forming performance.

In addition, by making the effective diameter D2 of the surface S2 that is closest to the reduction side 2 of the first lens group G1 relatively large compared to the second lens group G2, it is possible to reduce blocking of light rays (i.e., vignetting) by the first lens group G1 at the telephoto end. This means that it is possible to provide a lens system 10 that is brighter and has a lower F-number at the telephoto end. Accordingly, it is possible to provide the lens system 10 that has a simple and compact configuration, but has high image forming performance from the wide-angle end to the telephoto end and can project bright and sharp images.

The second lens group G2 may include a lens (enlargement-side lens) L2 with negative refractive power that is disposed closest to the enlargement side 3 and a lens (reduction-side lens) L4 with positive refractive power that is disposed closest to the reduction side 2. To distribute or divide the positive refractive power on the reduction side 2 and improve the correction of various aberrations, a lens L3 with positive refractive power disposed between the lenses L2 and L4 may also be included. The configuration of the second lens group G2 as a whole includes a negative-positive or so-called “retrofocus type” arrangement of refractive power where negative refractive power is disposed on the enlargement side 3. By doing so, it is possible to produce a state where the light rays on the reduction side 2 are in a telecentric or near telecentric state with a long back focus. Accordingly, it is possible to use a telecentric element (light valve), such as a liquid crystal display (LCD), as the image forming device 5. In addition, since divergence of light rays between the image forming device 5 and the lens system 10 can be suppressed, a lens system 10 suited to projection and image pickup of bright images can be provided.

The first lens group G1 may be composed of a single lens L1 with positive refractive power that is convex on the enlargement side, and the second lens group G2 may be composed of the enlargement-side lens L2 that has negative refractive power and includes the second end surface S4 that is concave on the enlargement side, the lens L3 that is positive refractive power and is convex on the reduction side 2, and the reduction-side lens L4 that has positive refractive power and is convex on the reduction side 2. The lens system 10 may be composed of a total of four lenses L1 to L4, and is capable of providing a bright, lightweight, and compact lens system including a small number of lenses.

The lens system 10 further includes a stop ST which is positioned closest to the reduction side 2 of the first lens group G1, moves together with the first lens group G1, and decides or defines the effective diameter of the first end surface S2 that is closest to the reduction side. In this lens system 10, the effective diameter DG1 (in the present embodiment, “D2”) of the first end surface S2 that is closest to the reduction side of the first lens group G1 defines the light flux at the telephoto end, and the effective diameter DG2 (in the present embodiment, “D4”) of the second end surface S4 that is closest to the enlargement side of the second lens group G2 defines the light flux at the wide-angle end. The effective diameter DG1 of the first end surface S2 may be decided with higher accuracy by the stop ST, and the effective diameter D3 of the stop ST may be the effective diameter of the first end surface S2. Accordingly, a stop that moves together with the second lens group G2 and decides or defines the effective diameter of the second end surface that is closest to the enlargement side 3 of the second lens group G2 may be provided on the enlargement side 3 of the second lens group G2. The lens system 10 according to the present embodiment uses a configuration where the second end surface S4 on the enlargement side 3 of the lens L2 closest to the enlargement side 3 in the second lens group G2 also serves as a stop. The second end surface S4 is concave on the enlargement side 3, and by making the first end surface S2 that is closest to the reduction side 2 in the first lens group G1 convex on the reduction side 2, it is possible to set a large bending angle for light rays at the second end surface S4 and to limit or qualify the light rays passing through the second end surface S4.

In the lens system 10, the focal length ft of the entire lens system at the telephoto end, the focal length fw of the entire lens system at the wide-angle end, the focal length f1 of the first lens group G1, and the focal length f2 of the second lens group G2 may satisfy the following conditions (1) and (2).

1<f1/ft<1.4 (1)

1<f2/fw<1.4 (2)

The positive-positive zoom lens system 10 is designed so that the refractive power of the second lens group G2 on the reduction side 2 is higher than the power of the first lens group G1 on the enlargement side 3. By sufficiently reducing the distance between the first lens group G1 and the second lens group G2 at the wide-angle end, it is possible to bring the refractive power of the system as whole close to the refractive power of the second lens group G2, and possible to obtain sufficient refractive power for wide-angle projection (image pickup or photography). By maintaining sufficient distance between the first lens group G1 and the second lens group G2 at the telephoto end, it is possible to bring the refractive power of the system as a whole close to the refractive power of the first lens group G1, and possible to provide a lens system suited to telephoto (that is, narrow angle) projection (image pickup or photography). The upper limits of conditions (1) and (2) may be 1.2.

The focal length f1 of the first lens group G1 and the focal length f2 of the second lens group G2 may satisfy the following condition (3).

1.5<f1/f2<2.5 (3)

Below the lower limit of condition (3), the ratio between the refractive powers of the first lens group G1 and the second lens group G2 is too small and the distance moved during zooming becomes too large, which makes it difficult to make the lens system 10 compact and also difficult to achieve sufficient brightness. If the upper limit of condition (3) is exceeded, the refractive power of the second lens group G2 will become extremely large, which makes it difficult to correct aberration in concert with the first lens group G1, resulting in poor image forming performance.

The effective diameter DG1 (in the present embodiment, the diameter D3 of the stop ST) of the first end surface (in the present embodiment, “S2”) that is closest to the reduction side 2 of the first lens group G1 and the effective diameter DG2 (in the present embodiment “D4”) of the second end surface (in the present embodiment, “S4”) on the enlargement side 3 of the second lens group G2 may satisfy the following condition (4).

1.4<DG1/DG2<2.5 (4)

Below the lower limit of condition (4), a large amount of light rays will be blocked by the first lens group G1 at the telephoto end, which makes it difficult to achieve sufficient brightness. If the upper limit of condition (4) is exceeded, the size of the first lens group G1 becomes large, making it difficult to make the zoom lens system 10 compact. The motive force required for movement during zooming and/or focusing also increases.

The focal length ft of the entire lens system at the telephoto end, the focal length fw of the entire lens system at the wide-angle end, the effective diameter DG1 of the surface closest to the reduction side 2 of the first lens group G1, and the effective diameter DG2 of the surface closest to the enlargement side 3 of the second lens group G2 may satisfy the following condition (5).

0.8<(fw/DG2)/(ft/DG1)<1.2 (5)

Here, (fw/DG2) relates to the efficiency of light capture of the lens system 10 at the wide-angle end and (ft/DG1) relates to the efficiency of light capture of the lens system 10 at the telephoto end. By satisfying condition (5), it is possible to keep the brightness almost constant at the telephoto end and the wide-angle end.

Accordingly, the F number Fw of the lens system 10 at the wide-angle end and the F number Ft at the telephoto end may satisfy the following condition (6).

0.8<Fw/Ft<1.2 (6)

The lower limit of condition (6) may be 0.9 and the upper limit may be 1.1.

The radius of curvature R2 (in the present embodiment, “r4”) of the second end surface (in the present embodiment, the surface S4) that is closest to the enlargement side 3 of the second lens group G2 is small relative to the radius of curvature R1 (in the present embodiment, “r2”) of the first end surface (in the present embodiment, “S2”) that is closest to the reduction side 2 of the first lens group G1, so that the curvature of the second end surface S4 may be large relative to the first end surface S2. This ensures that the second end surface S4 will sufficiently contribute to the Petzval sum, and possible to effectively use the second end surface S4 as a stop.

The radius of curvature R1 and the radius of curvature R2 may satisfy the following condition (7).

5<|R1/R2|<20 (7)

Below the lower limit of condition (7), the radius of curvature of the surface that is closest to the enlargement side 3 of the second lens group G2 cannot be sufficiently reduced, and the contribution to the Petzval sum is small. This makes it difficult to favorably correct aberration. If the upper limit of condition (7) is exceeded, the difference between the radius of curvature of the surface that is closest to the enlargement side 3 of the second lens group G2 and the radius of curvature of the surface in the first lens group G1 that faces the surface of the second lens group is too large, which makes it difficult to correct aberration caused by these surfaces.

The first end surface S2 closest to the reduction side 2 of the first lens group G1 may be a surface that is convex on the reduction side 2. This makes it possible to reduce the curvature of the surface closest to the enlargement side 3 in the first lens group G1 that has positive refractive power, which makes it easy to improve the aberration in the first lens group G1. Typically, the first lens group G1 may include a lens L1 with a surface that is convex on the reduction side and positioned closest to the reduction side 2, and the first lens group G1 may be composed of a single lens, the lens L1, that has positive refractive power. In the lens system 10, the first lens group G1 is composed of a single lens L1 with positive refractive power, and the second lens group G2 may be constructed of a larger number of lenses than the first lens group G1, for example, at least two lenses with a negative-positive arrangement of refractive powers.

The lens L1 of the first lens group G1 may be a positive lens that is convex on the enlargement side 3. The radius of curvature r2 of the surface on the reduction side 2 of the lens L1 may be larger than the radius of curvature r1 of the surface on the enlargement side 3, and the following condition (8) may be satisfied.

0.1<|r1/r2|<0.5 (8)

If the radius of curvature r2 of the surface on the reduction side 2 facing the concave surface of the second lens group G2 on the reduction side 2 is too small, the generated aberration increases, making it difficult to achieve sufficient image forming performance for the lens system 10. Both surfaces of the lens L1 may be aspherical. The lens surface S1 on the enlargement side 3 of the lens L1 may be an aspherical surface where the radius of curvature increases toward the periphery, and the lens surface S2 on the reduction side 2 may be an aspherical surface where the radius of curvature decreases toward the periphery.

The distance Lt (in the present embodiment, “d3” at the telephoto end) and the distance Lw at the wide-angle end (in the present embodiment, “d3” at the wide-angle end) on the optical axis 7 at the telephoto end from the first end surface (in the present embodiment “S2”) that is closest to the reduction side 2 of the first lens group G1 to the second end surface (in the present embodiment “S4”) closest to the enlargement side 3 of the second lens group G2 may satisfy the following condition (9).

5<Lt/Lw<15 (9)

Below the lower limit of condition (9), it is difficult to achieve a sufficient zoom ratio, and if the upper limit is exceeded, it is difficult to provide a bright lens system.

The Abbe number vdp of each positive lens included in the entire lens system 10 and the Abbe number vdn of each negative lens included in the entire lens system may satisfy the following conditions (10) and (11).

35<vdp<85 (10)

20<vdn<40 (11)

In more detail, the lens system 10 depicted in FIG. 1 includes, in order along the optical axis 7, the first lens group G1 that is made up of the lens L1 with positive refractive power and the second lens group G2 which is composed of three lenses L2 to L4 with negative-positive-positive refractive powers in order from the enlargement side 3. The lens L1 that constructs the first lens group G1 is a biconvex positive lens, where the radius of curvature r1 of the surface S1 on the enlargement side 3 is smaller (in absolute value) than the radius of curvature r2 of the surface S2 on the reduction side 2. The stop ST is disposed adjacent to the surface S2 on the reduction side 2 of the lens L1. Among the lenses that constructs the second lens group G2, the lens L2 is a biconcave negative lens, and the lenses L3 and L4 are biconvex positive lenses. In the lens system 10, the distance between the first lens group G1 and the second lens group G2 decreases and the distance between the second lens group G2 and the image forming device 5 increases from the telephoto end to the wide-angle end.

Various numerical values of this lens system 10 and the values of the respective conditions are as follows. Note that the unit used for lengths and diameters is mm.
F number: telephoto end (infinity) Ft: 1.3, wide-angle end (infinity) Fw: 1.2
Angle of view: 15.00 at telephoto end, 30.00 at wide-angle end
Focal length ft of lens system 10 at telephoto end: 238.65
Focal length fw of lens system 10 at wide-angle end: 118.56
Zoom ratio: 2.01
Focal length f1 of first lens group G1: 244.73
Focal length f2 of second lens group G2: 132.44
Effective diameter DG1 (D3) of first end surface closest to reduction side of first lens group G1: 177.76
Effective diameter DG2 (D4) of second end surface closest to enlargement side of second lens group G2: 91.6
Radius of curvature R1 (r2) of first end surface closest to reduction
side of first lens group G1: −700.14
Radius of curvature R2 (r4) of second end surface closest to
enlargement side of second lens group G2: −92.86
Distance Lt (d3) between lens groups G1 and G2 at telephoto end: 154.89
Distance Lw (d3) between lens groups G1 and G2 at wide-angle end: 17.32
Condition (1) (f1/ft): 1.03
Condition (2) (f2/fw): 1.12
Condition (3) (f1/f2): 1.85
Condition (4) (DG1/DG2): 1.94
Condition (5) ((fw/DG2)/(ft/DG1)): 0.96
Condition (6) (Fw/Ft): 0.92
Condition (7) (|R1/R2|): 7.54
Condition (8) (|r1/r2|): 0.2
Condition (9) (Lt/Lw): 8.94
Condition (10) (35<vdp<85): Satisfied
Condition (11) (20<vdn<40): Satisfied

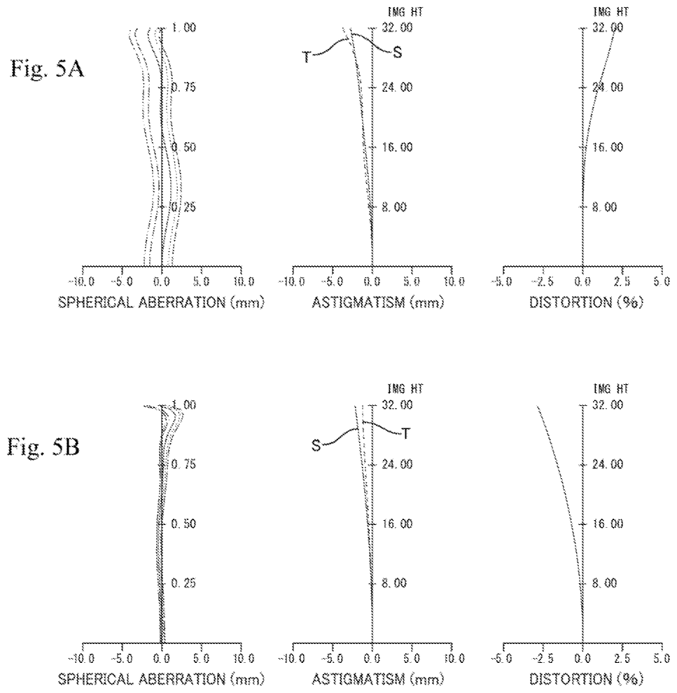

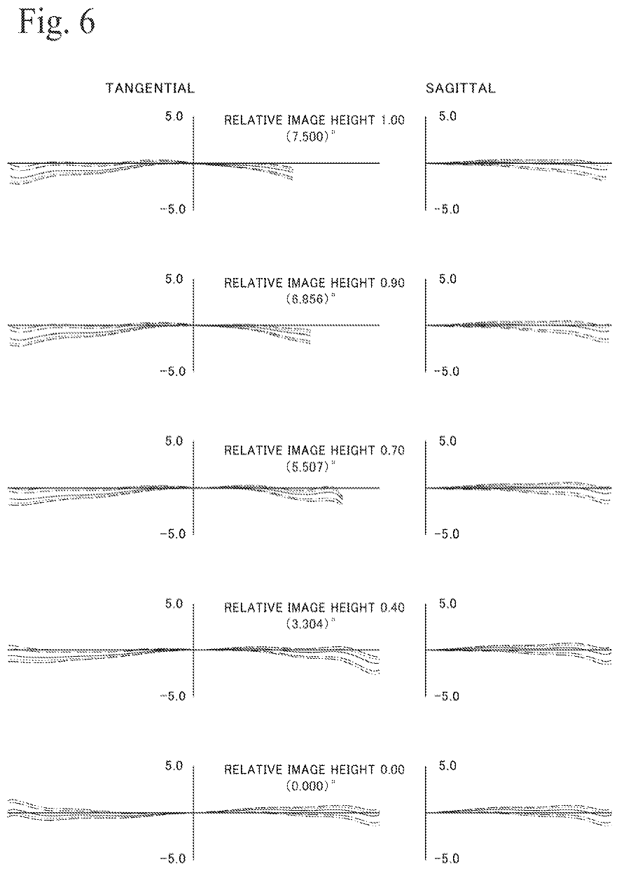

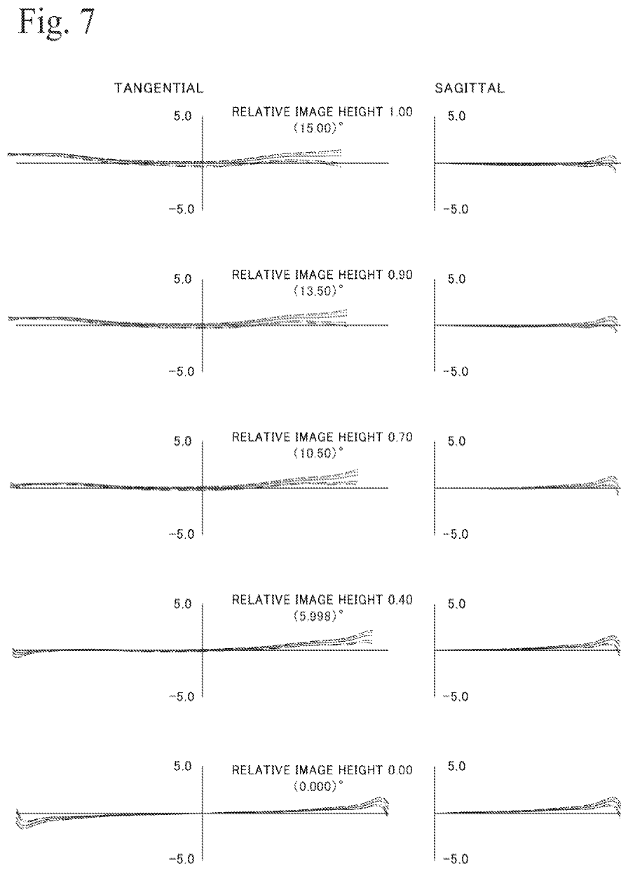

FIG. 5A depicts longitudinal aberrations at the telephoto end, FIG. 5B depicts longitudinal aberrations at the wide-angle end, FIG. 6 depicts lateral aberrations at the telephoto end, and FIG. 7 depicts lateral aberrations at the wide-angle end. Spherical aberrations are indicated for a wavelength of 680.0 nm (long dash line), a wavelength of 620.0 nm (short dash line), a wavelength of 550.0 nm (solid line), a wavelength of 460.0 nm (dot-dash line), and a wavelength of 430.0 nm (dot-dot-dash line). Astigmatisms are indicated for tangential rays T and sagittal rays S. Lateral aberrations areindicated for the same wavelengths as above for each of tangential and sagittal rays.

As indicated above, the lens system 10 depicted in FIG. 1 satisfies all of conditions (1) to (11) and, in spite of being a compact zoom lens system with four elements in two groups, is a zoom lens system with a zoom ratio of 2.0 which is capable of projecting bright and clear images with an F number that is almost constant at the telephoto end and the wide-angle end.

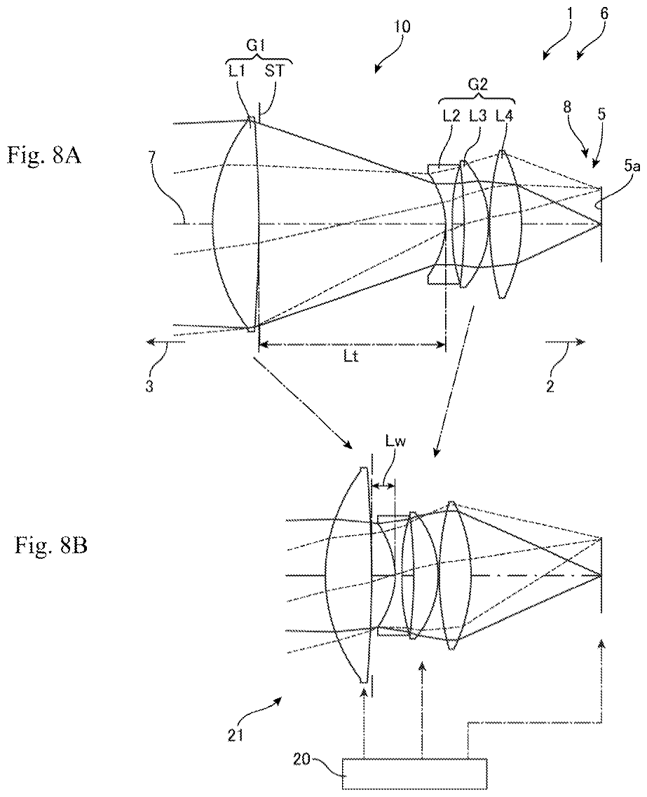

FIGS. 8A and 8B depict a different example of the projector 1. FIG. 8A depicts the lens arrangement of the lens system 10 at the telephoto end, and FIG. 8B depicts the lens arrangement of the lens system 10 at the wide-angle end. This projector 1 also includes a lens system 10 and an image forming device 5 disposed at a conjugate plane on the reduction side 2. The projector 1 further includes a lens unit 21 including the lens system 10 and the driving unit 20 capable of controlling the position of at least one of the first lens group G1, the second lens group G2, and the device 5. The lens system 10 is a zoom lens system for a projector, and in the same way as the example described above, has a two-group, four-lens configuration. The first lens group G1 on the enlargement side 3 of the lens system 10 is composed of a single biconvex positive lens L1 that moves integrally with a stop ST disposed on the reduction side 2. The second lens group G2 is composed of three lenses, a biconcave negative lens L2, a negative meniscus lens L3 that is convex on the reduction side 2, and a biconvex positive lens L4, which move integrally. Other configurations of the lens system are the same as the lens system described above, including the direction of movement.

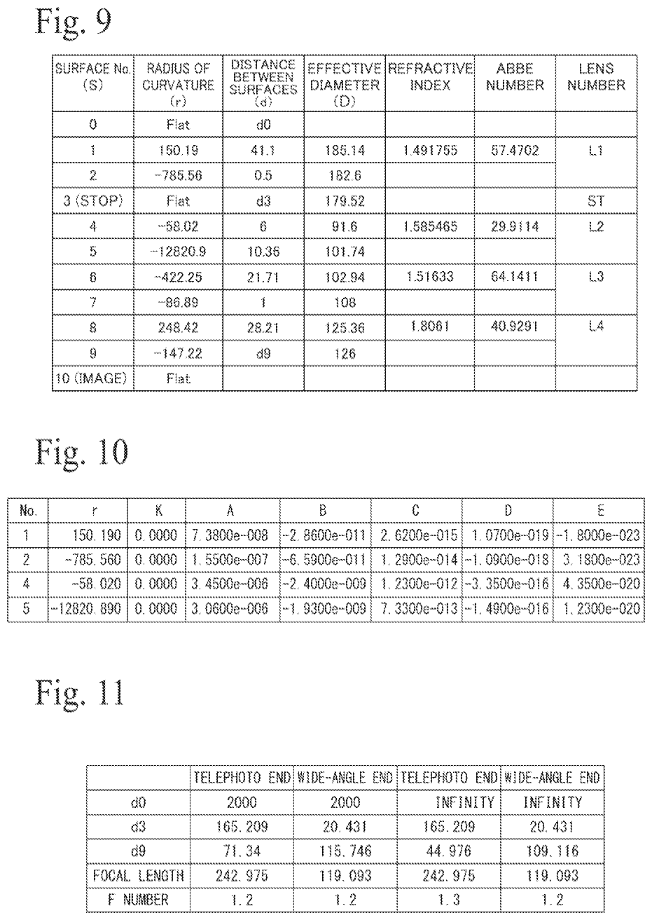

FIG. 9 indicates data on each lens that constructs the lens system 10. FIG. 10 indicates coefficients of the aspherical surfaces included in the lens system 10. In this example, both surfaces of the lens L1 in the first lens group G1 and both surfaces of the lens L2 that is closest to the enlargement side 3 of the second lens group G2 are aspherical.

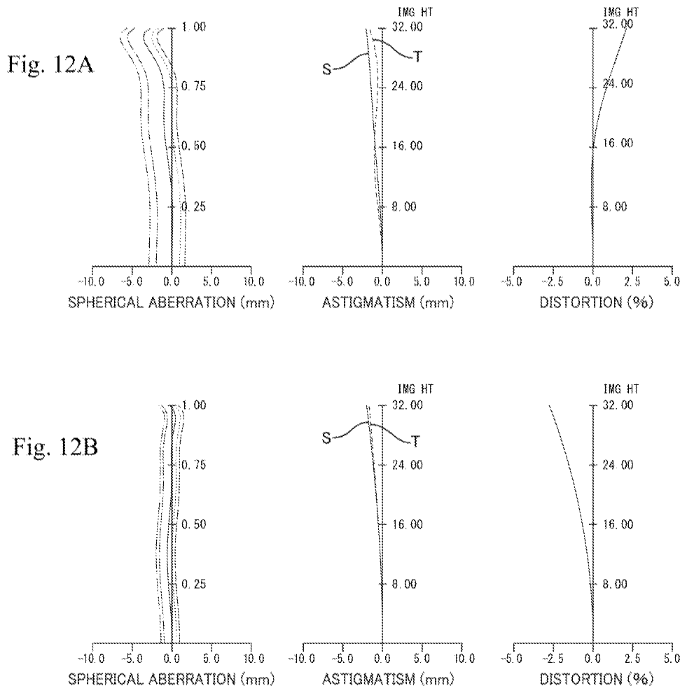

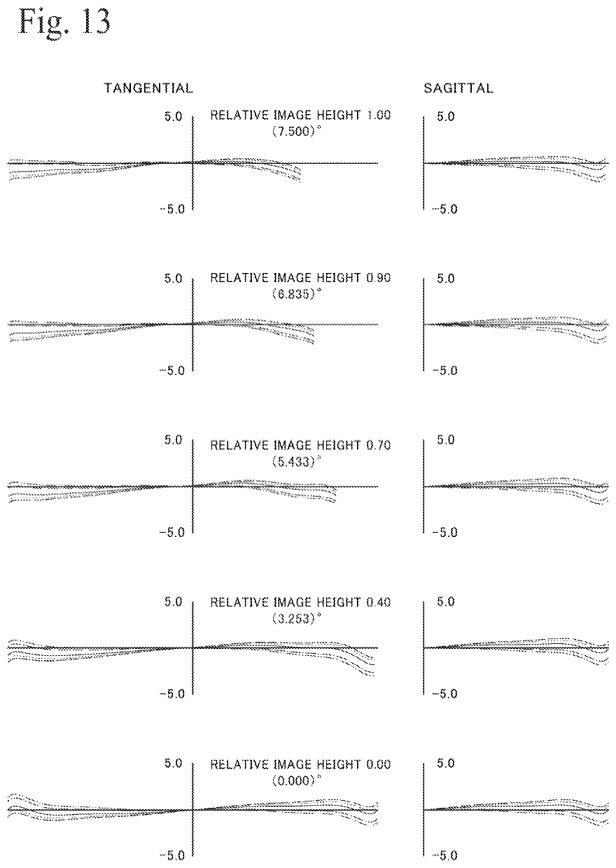

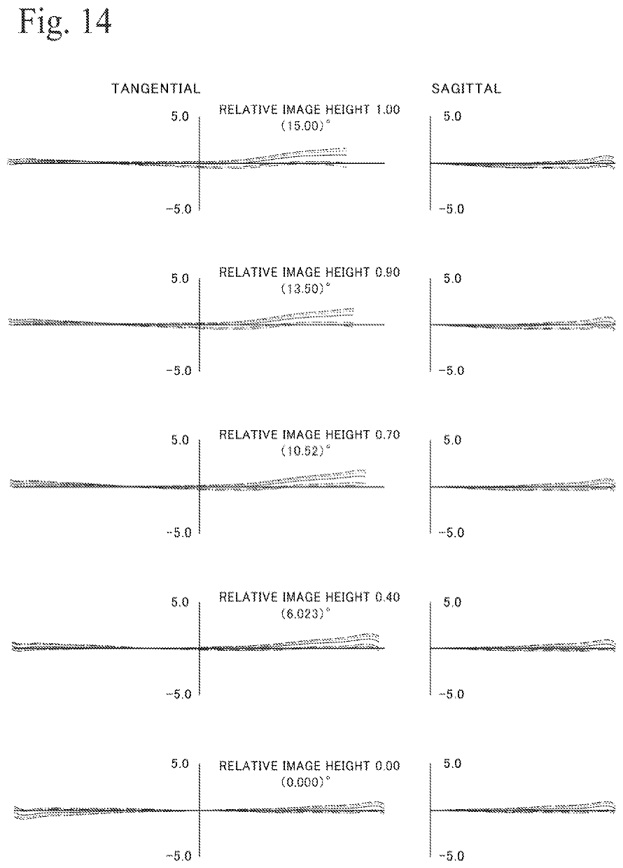

FIG. 11 indicates various numerical values at the telephoto end and the wide-angle end of the lens system 10, FIGS. 12A and 12B depict spherical aberration, astigmatism, and distortion of the lens system 10, and FIGS. 13 and 14 depict lateral aberrations of the lens system 10. FIGS. 12A and 13 depict various aberrations at the telephoto end, and FIGS. 12B and 14 depict various aberrations at the wide-angle end.

Various numerical values of this lens system 10 and the values of the respective conditions are as follows.
F number: telephoto end (infinity) Ft: 1.3, wide-angle end (infinity) Fw: 1.2
Angle of view: 15.00 at telephoto end, 30.00 at wide-angle end
Focal length ft of lens system 10 at telephoto end: 242.98
Focal length fw of lens system 10 at wide-angle end: 119.10
Zoom ratio: 2.04
Focal length f1 of first lens group G1: 259.21
Focal length f2 of second lens group G2: 129.37
Effective diameter DG1 (D3) of surface closest to reduction side of
first lens group G1: 179.52
Effective diameter DG2 (D4) of surface closest to enlargement side of
second lens group G2: 91.6
Radius of curvature R1 (r2) of surface closest to reduction side of first lens group G1: −785.56
Radius of curvature R2 (r4) of surface closest to enlargement side of the second lens group G2: —58.02
Distance Lt (d3) between lens groups G1 and G2 at telephoto end: 165.21
Distance Lw (d3) between lens groups G1 and G2 at wide-angle end: 20.43
Condition (1) (f1/ft): 1.07
Condition (2) (f2/fw): 1.09
Condition (3) (f1/f2): 2.00
Condition (4) (DG1/DG2): 1.96
Condition (5) ((fw/DG2)/(ft/DG1)): 0.96
Condition (6) (Fw/Ft): 0.92
Condition (7) (|R1/R2|): 13.5
Condition (8) (|r1/r2|): 0.19
Condition (9) (Lt/Lw): 8.09
Condition (10) (35<vdp <85): Satisfied
Condition (11) (20<vdn <40): Satisfied

As indicated above, the lens system 10 depicted in FIG. 8 satisfies all of conditions (1) to (11) and is a compact zoom lens system with four elements in two groups, has a zoom ratio of 2.0, and is capable of projecting bright and clear images with an F number that is almost constant at the telephoto end and the wide-angle end.

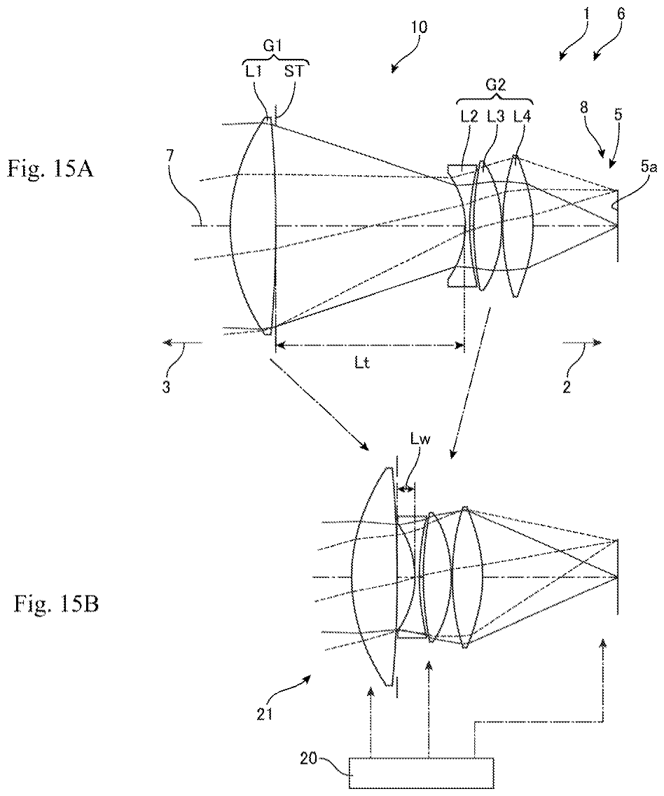

FIGS. 15A and 15B depict yet another example of the projector 1. FIG. 15A depicts the lens arrangement of the lens system 10 at the telephoto end, and FIG. 15B depicts the lens arrangement of the lens system 10 at the wide-angle end. This projector 1 also includes a lens system 10 and an image forming device 5 disposed at a conjugate plane on the reduction side 2. The projector 1 further includes a lens unit 21 including the lens system 10 and a driving unit 20 capable of controlling the position of at least one of the first lens group G1, the second lens group G2, and the device 5. The lens system 10 is a zoom lens system for a projector, and in the same way as the examples described above, has a two-group, four-lens configuration. The first lens group G1 on the enlargement side 3 of the lens system 10 is composed of a single biconvex positive lens L1 that moves integrally with a stop ST disposed on the reduction side 2. The second lens group G2 is composed of three lenses, a biconcave negative lens L2, and two positive biconvex lenses L3 and L4, all of which move integrally. Other configurations of the lens system are the same as the lens system described above, including the direction of movement.

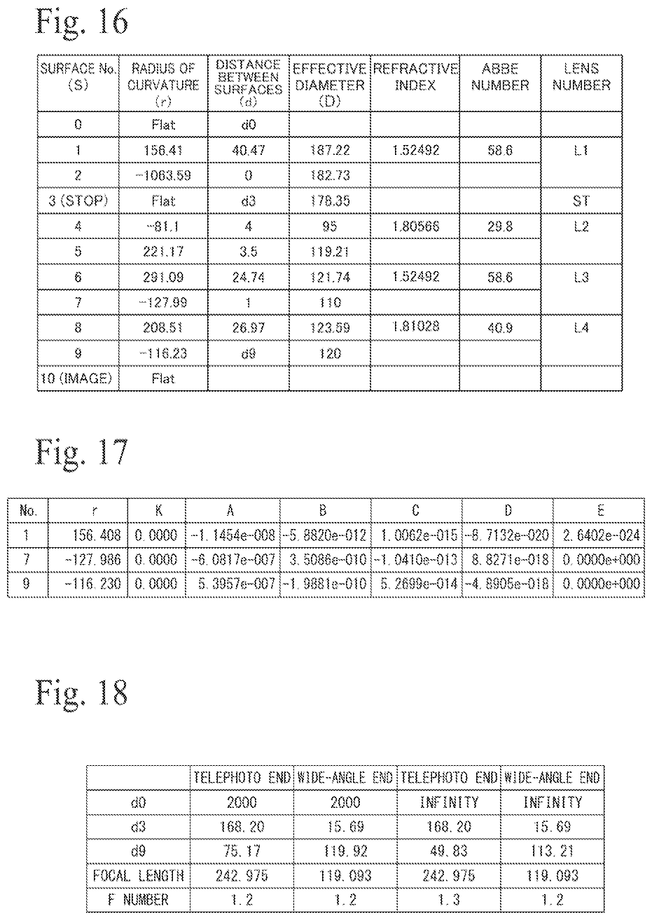

FIG. 16 indicates data on each lens that constructs the lens system 10. FIG. 17 indicates coefficients of the aspherical surfaces included in the lens system 10. In this example, the surface on the enlargement side 3 of the lens L1 in the first lens group G1 and the surfaces on the respective reduction sides 2 of the lenses L3 and L4 in the second lens group G2 are aspherical.

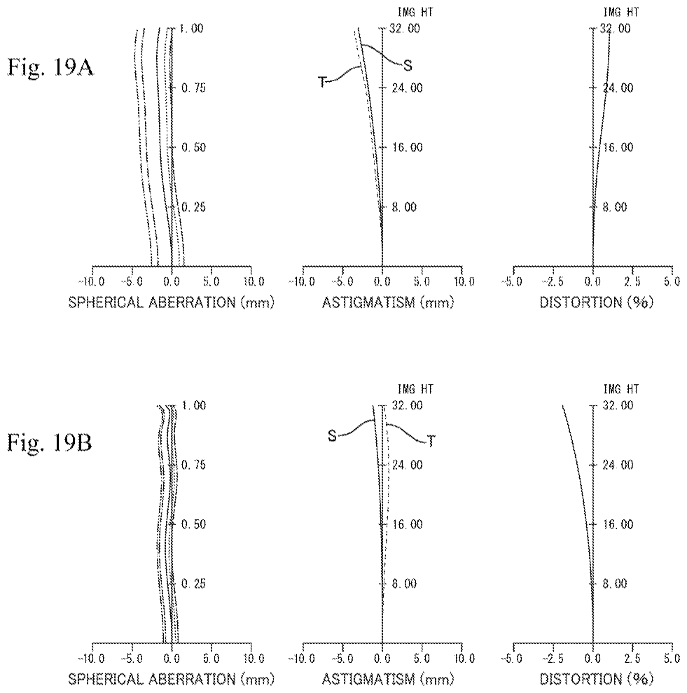

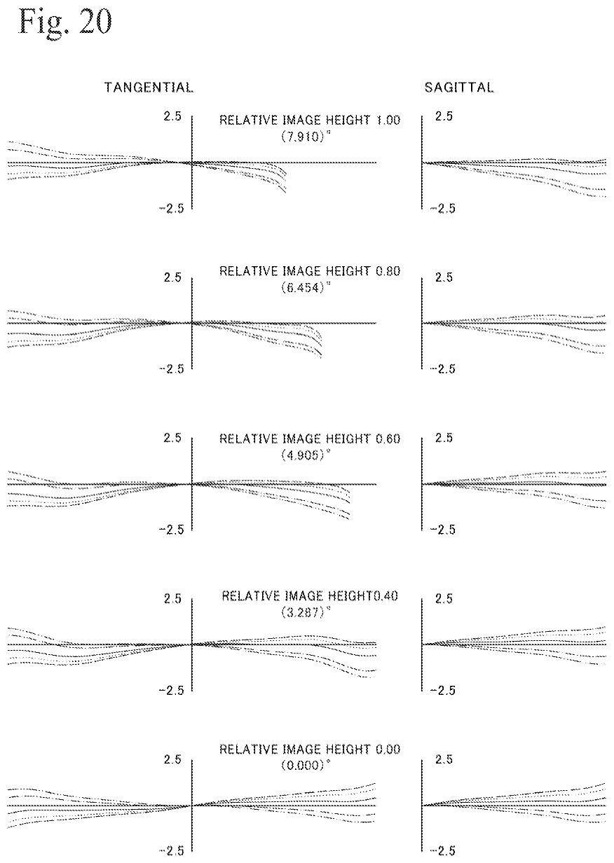

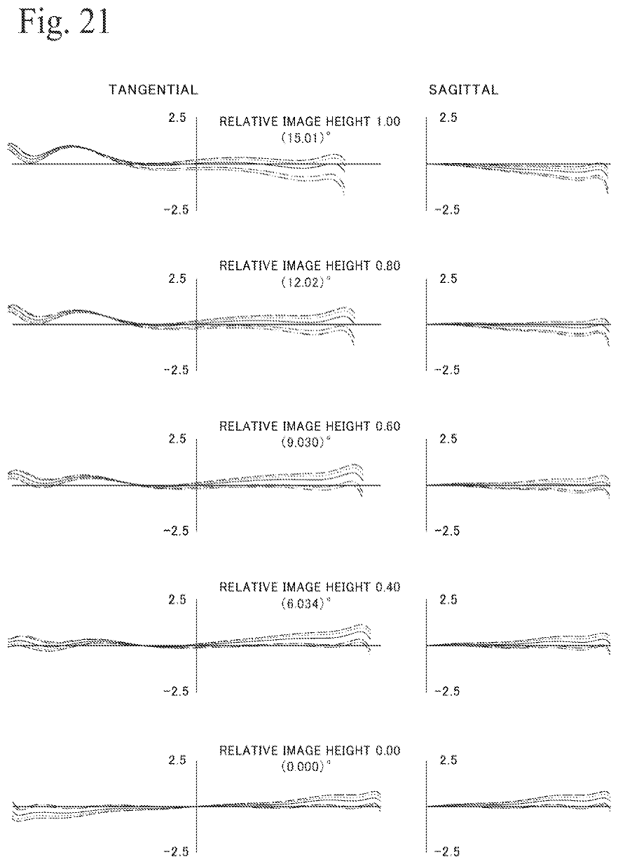

FIG. 18 indicates various numerical values at the telephoto end and the wide-angle end of the lens system 10, FIGS. 19A and 19B depict spherical aberration, astigmatism, and distortion of the lens system 10, and FIGS. 20 and 21 depict lateral aberrations of the lens system 10. FIGS. 19A and 20 depict various aberrations at the telephoto end, and FIGS. 19B and 21 depict various aberrations at the wide-angle end.

Various numerical values of this lens system 10 and the values of the respective conditions are as follows.
F number: telephoto end (infinity) Ft: 1.3, wide-angle end (infinity) Fw: 1.2
Angle of view: 15.02 at telephoto end, 29.90 at wide-angle end
Focal length ft of lens system 10 at telephoto end: 242.98
Focal length fw of lens system 10 at wide-angle end: 119.10
Zoom ratio: 2.04
Focal length f1 of first lens group G1: 263.72
Focal length f2 of second lens group G2: 136.37
Effective diameter DG1 (D3) of surface closest to reduction side of
first lens group G1: 178.35
Effective diameter DG2 (D4) of surface closest to enlargement side of
second lens group G2: 95.0
Radius of curvature R1 (r2) of surface closest to reduction side of first
lens group G1: −1063.59
Radius of curvature R2 (r4) of surface closest to enlargement side of
second lens group G2: −81.1
Distance Lt (d3) between lens groups G1 and G2 at telephoto end: 168.20
Distance Lw (d3) between lens groups G1 and G2 at wide-angle end: 15.69
Condition (1) (f1/ft): 1.09
Condition (2) (f2/fw): 1.15
Condition (3) (f1/f2): 1.93
Condition (4) (DG1/DG2): 1.88
Condition (5) ((fw/DG2)/(ft/DG1)): 0.92
Condition (6) (Fw/Ft): 0.92
Condition (7) (|R1/R2|): 13.1
Condition (8) (|r1/r2|): 0.15
Condition (9) (Lt/Lw): 10.7
Condition (10) (35<vdp <85): Satisfied
Condition (11) (20<vdn <40): Satisfied

As indicated above, the lens system 10 depicted in FIGS. 15A and 15B satisfies all of conditions (1) to (11), is a compact zoom lens system with four elements in two groups, has a zoom ratio of 2.0, and is capable of projecting bright and clear images with an F number that is almost constant at the telephoto and wide-angle ends.

The invention claimed is:

1. A lens system consisting of, in order from an enlargement side, a first lens group with positive refractive power and a second lens group with positive refractive power,
wherein when zooming from a telephoto end to a wide-angle end, a distance between the first lens group and the second lens group decreases and a distance between the second lens group and a conjugate plane on a reduction side increases,
in the first lens group, an effective diameter of a first end surface closest to the reduction side is larger than a maximum diameter of the second lens group, and
the second lens group includes, closest to the enlargement side thereof, an enlargement-side lens with a second end surface that is concave on the enlargement side.

2. The lens system according to claim 1,
wherein the second lens group includes the enlargement-side lens, which has negative refractive power and is disposed closest to the enlargement side, and a reduction-side lens, which has positive refractive power and is disposed closest to the reduction side.

3. The lens system according to claim 2,
wherein the first lens group is composed of a single lens with positive refractive power that is convex on the enlargement side, and
the second lens group is composed of the enlargement-side lens, which has negative refractive power and includes the second end surface that is concave on the enlargement side, a lens with positive refractive power that is convex on the reduction side, and the reduction-side lens, which has positive refractive power and is convex on the reduction side.

4. The lens system according to claim 1,
wherein an effective diameter of the first end surface closest to the reduction side of the first lens group defines a light flux at the telephoto end, and
an effective diameter of the second end surface closest to the enlargement side of the second lens group defines a light flux at the wide-angle end.

5. The lens system according to claim 4,
wherein the first lens group includes, closest to the reduction side of the first lens group, a stop that moves together with the first lens group and defines the effective diameter of the first end surface closest to the reduction side.

6. The lens system according to claim 1,
wherein the first end surface of the first lens group is a surface that is convex on the reduction side.

7. The lens system according to claim 1,
wherein a focal length ft of the lens system at the telephoto end, a focal length fw of the lens system at the wide-angle end, a focal length f1 of the first lens group, and a focal length f2 of the second lends group satisfy following coniditons.
1<f1/fw<1.4
1<f2/fw<1.4.

8. The lens system according to claim 1,
wherein a focal length f1 of the first lens group and a focal length f2 of the second lens group satisfy a following condition.
1.5<f1/f2<2.5.

9. The lens system according to claim 1,
wherein an effective diameter DG1 of the first end surface closest to the reduction side of the first lens group and an effective diameter DG2 of the second end surface closest to the enlargement side of the second lens group satisfy a following condition.
1.4<DG1/DG2<2.5.

10. The lens system according to claim 1,
wherein a focal length ft of the lens system at the telephoto end, a focal length fw of the lens system at the wide-angle end, an effective diameter DG1 of the first end surface closest to the reduction side of the first lens group, and an effective diameter DG2 of the second end surface closest to the enlargement side of the second lens group satisfy a following condition.
0.8<(fw/DG2)/(ft/DG1)<1.2.

11. The lens system according to claim 1,
wherein a radius of curvature R2 of the second end surface closest to the enlargement side of the second lens group is smaller than a radius of curvature R1 of the first surface closest to the reduction side of the first lens group.

12. The lens system according to claim 1,
wherein a radius of curvature R1 of the first surface closest to the reduction side of the first lens group and a radius of curvature R2 of the second end surface closest to the enlargement side of the second lens group satisfy the following conditions.
5<|R1/R2|<20.

13. The lens system according to claim 1,
wherein a distance Lt at the telephoto end and a distance Lw at the wide-angle end from the first end surface closest to the reduction side of the first lens group to the second end surface closest to the enlargement side of the second lens group satisfy a following condition.
5<Lt/Lw<15.

14. A lens unit comprising:
the lens system according to claim 1; and
a driving unit that moves at least one of the first lens group, the second lens group, and the conjugate plane on the reduction side, alone or in concert.

15. A projector comprising:
the lens system according to claim 1; and
an image forming device disposed at the conjugate plane on the reduction side.

16. An image pickup apparatus comprising:
the lens system according to claim 1; and
an image pickup element disposed at the conjugate plane on the reduction side.
